(19) United States
(12) Patent Application Publication
(10) Pub. No.: US 2008/0289844 A1
(43) Pub. Date: Nov. 27, 2008

(54) DECORATIVE RECEPTACLE AND SWITCH COVERS

(76) Inventor: William E. Dutton, JR., Frankfort, IL (US)

Correspondence Address: SACHNOFF & WEAVER, LTD., 10 SOUTH WACKER DRIVE, CHICAGO, IL, 60606-7507, US

(21) Appl. No.: 12/120,049

(22) Filed: May 13, 2008

Related U.S. Application Data
(60) Provisional application No. 60/939,879, filed on May 24, 2007.

(51) Int. Cl. H02G 3/14

(52) U.S. Cl. 174/66

(57) ABSTRACT

A decorative electrical socket cover is provided to be placed over an electrical socket of an electrical outlet assembly. The outlet assembly is located on a wall or other surface that is finished in a predetermined color, and a user desires that the color of the socket cover match the color of the wall or other surface. The decorative socket cover comprises a socket cup body having flat outwardly and inwardly facing surfaces and a rim portion extending around the perimeter of the socket cup body at substantially a right angle to the plane of the inwardly facing flat surface. A plurality of apertures are located in the socket cup body which apertures correspond in size and location to a corresponding plurality of slots in the socket. The rim portion of the cup body includes an inner surface having a gripping surface, wherein the gripping surface of the rim portion is adapted to engage an outer perimeter of the socket and removably attach the socket cup body to the socket. In an additional embodiment, a sleeve having a chamber and a tacky glue material is adapted to fit over and be held to the finger manipulable portion of a wall switch, whereby the sleeve's outer surface is a predetermined color as selected by the user.

### CROSS REFERENCE TO RELATED APPLICATION

This application claims priority to provisional patent application Ser. No. 60/939,879 filed May 24, 2007, to the extent allowed by law.

### FIELD OF THE INVENTION

The present invention relates generally to decorative electrical receptacle covers, and more specifically to replaceable decorative receptacle covers that are adapted to cover wall mounted electrical sockets and switches such that when the color or décor of a room is changed, the color of the socket or wall switch may also be modified to match or otherwise highlight the color and décor of the room. The outer surface of the covers comprising the present invention may include a predetermined color that matches or coordinates with the color of the surrounding wall.

### BACKGROUND OF THE INVENTION

One of the current problems in any home/office during reconstruction or redecorating is that there are limited color options available for purchase with regard to commonly available wall mounted electrical outlets, sockets and switches. The current color standard for such outlets, sockets and switches are white, off-white, brown, and black. Electrical outlets usually are configured in round plug shapes, or rectangular plug shapes with curved ends, and a cover plate fits over the outlets. Switches normally comprise a finger-operable portion extending outward from the switch mechanism and through a rectangular aperture in a wall plate.

Currently, any time that the wall color is changed in a particular room, the color of the outlets and switches may not match as well as they did with the previous color. While homeowners and office managers often purchase new switch plates, the option of changing the outlets or switches is costly, time consuming and potentially dangerous. In addition to the cost of the new outlet or switch, most individuals must also expend funds to hire an electrician to replace the outlet or switch. Even with this extra expense, at the present time, the only options available for outlets and switches are: white, black, off-white or brown. Moreover, often a perfectly good outlet is removed just because of its color.

To resolve the above problems, an embodiment of the present invention provides a decorative electrical outlet cover designed and constructed to be placed over an existing electrical outlet located on a wall or other surface, the wall or other surface being finished in a predetermined color, where a user desires that the color of the outlet cover match or coordinate with the color of the surrounding wall or other surface. The decorative outlet cover includes an outlet cup having a flat surface, and a rim portion extending around the perimeter of the outlet cup at substantially a right angle to the plane of the flat surface. A flange extends outwardly from the cover rim portion, and along the perimeter of the rim portion. The outlet cup is adapted to snugly fit over the electrical outlet, and a pair of slots are formed in the outlet cup corresponding in size and location to a corresponding pair of slots in the outlet. A face plate is disposed over the electrical outlet and the outlet cover, the face plate having a portion that bears against the flange portion of the cover to hold the outlet cup in place against the outlet.

An additional embodiment of the present invention provides a decorative cover for a manually operable electrical switch. The switch cover includes a sleeve having a closed hollow chamber internally disposed in the sleeve. The sleeve is adapted to be placed over the electrical switch by inserting the wall switch into the closed hollow chamber. Adhesive material is disposed in the chamber to provide a firm but releasable connection between the sleeve and the electrical switch.

### BRIEF DESCRIPTION OF THE DRAWINGS

The above mentioned and other features of the present invention, and the manner of obtaining them, will become more apparent, and the invention itself will be best understood with reference to the following description of the embodiments of the invention taken in conjunction with the accompanying drawings, in which:

FIG. 1 is a perspective view of the face or cover plate and two outlet cups of an embodiment of the present invention located in apertures in the cover plate;

FIG. 2 is a cross-sectional view of the face or cover plate and outlet cups of the present invention, taken along line 2-2 in FIG. 1, and shown mounted to a typical electric outlet assembly;

FIG. 3 is an exploded perspective view of a typical dual socket electric receptacle assembly and face or cover plate, illustrating the embodiment of the invention shown in FIGS. 1 and 2 prior to installation of the outlet cups over the sockets of the receptacle assembly;

FIG. 4 is a perspective view of an embodiment of the present invention wherein the outlet cup structure being held by the face or cover plate is adapted to cover two adjacent sockets in an electrical receptacle assembly;

FIG. 5 is a cross-sectional view of the face or cover plate and single outlet cup structure of an embodiment of the present invention, taken along line 5-5 in FIG. 4;

FIG. 6 is an exploded perspective view illustrating the embodiment of the invention shown in FIGS. 4 and 5, prior to installation of the single outlet cup over the sockets of the receptacle assembly; and

FIG. 7 is a side view of an embodiment of the present invention where a decorative sleeve is positioned over the projecting portion of an electrical wall switch.

### DETAILED DESCRIPTION OF THE ILLUSTRATED EMBODIMENTS

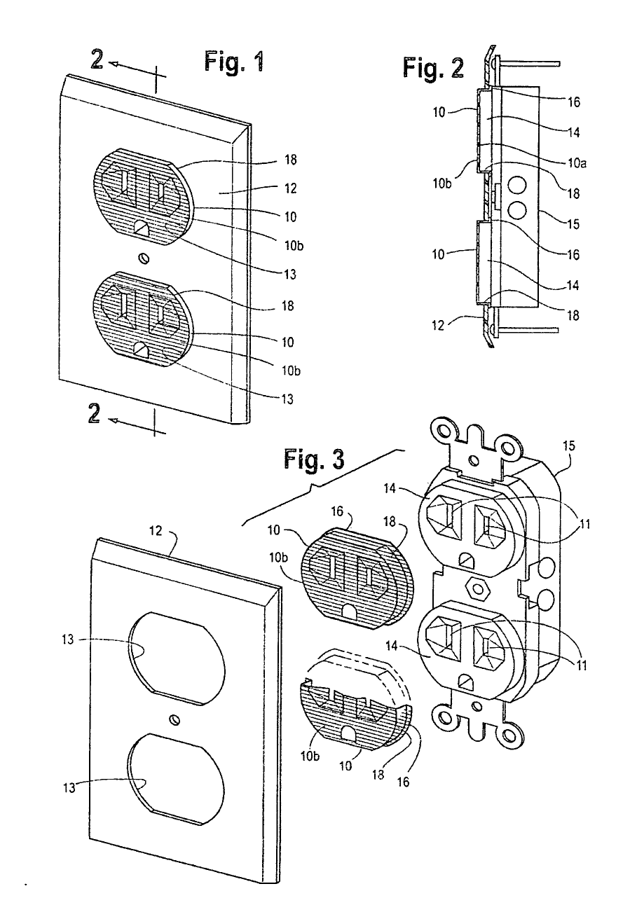

One embodiment of the present invention is illustrated in FIGS. 1, 2 and 3, and comprises outlet cups 10 and matching switch face plate cover 12 with slightly larger apertures 13 than usually formed in present switch plate covers. Each cup 10 comprises an inward facing flat surface 10a and an outward facing flat surface 10b. Outlet cups 10 are installed piggy back fashion onto the existing electrical sockets or outlets 14 (FIGS. 2, 3) as will be explained, and the cups 10 may be made of nonflammable, nonconductive material that is adapted to hold paint and/or stains (e.g., the same material that outlets are currently made of). The outlet cups 10 are molded and configured to fit the most popular brands of receptacles 15 having outlets 14. In this embodiment, each cup 10 is independent of the other, allowing for differences in center to center socket dimensions for older receptacles. Each cup 10 is also made to a minimum thickness to avoid problems with the plug and potential arcing. The cups 10 are also slightly bigger than the current outlets 14 to allow each cup 10 to fit over the existing outlet and slide over the outlet 14 a distance of approximately ⅛″.

In an embodiment, each cup 10 has a ⅛″ to ¼″ outwardly extending lip or flange 16 around the outside perimeter to cover any gap between the receptacle and the face plate 12 when installed. Flange 16 is attached to a downward extending rim portion 18 of cup 10, as seen in FIGS. 2 and 3. Rim portion 18 has an inner surface that provides a gripping surface to engage the outer perimeter of socket 14, and removably and snugly attach the cup body 10 to the socket 14. The flange 16 also holds the cup 10 onto and over the outlet 14 once the face plate 12—the new matching cover plate—is screwed on top of the cup 10 over flange 16 as is known in the art.

As seen in FIG. 3, each socket 14 has a pair of apertures 11 adapted to receive the connector prongs of a male electrical plug (not shown). Each cup 10 includes a pair of apertures 17 that correspond in size and relative position to apertures 11. When each cup 10 is placed over a socket 14, the pair of apertures 17 in the cup align with the pair of apertures 11 in the socket.

People who are hesitant to work on electrical systems would not likely be afraid to unscrew one screw, and place the cups 10 over the outlets 14 and replace the old cover plate with a new matching cover plate 12. The cups 10 are designed to have an outside measurement slightly larger than the standard receptacle outlet 14 to enable each cup to fit snugly over the outlet. Each cup 10 would be molded out of relatively thin material to allow the cup to have adequate depth to remain in place over the outlet 14 when a male electrical plug is inserted in the outlet 14, without coming out and/or creating arcing. Each cup 10 also has a depth adequate to provide for the thickness of the cover plate 12, and the flange 16 around the cup 10 allows the cover plate 12 to hold each cup against the receptacle 15 when the cover plate is screwed in place over the sockets 14 and the cups 10.

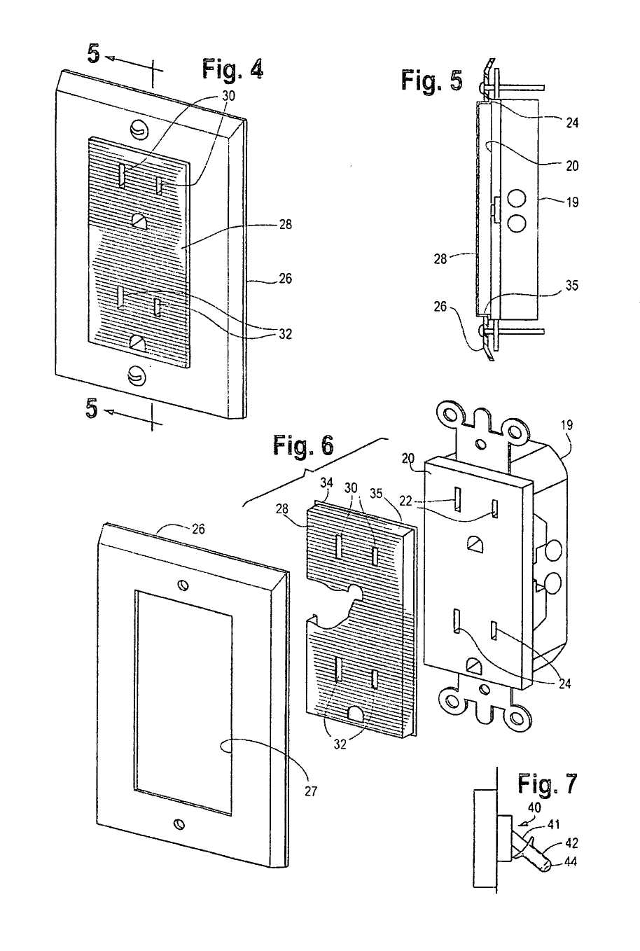

In an additional embodiment of the present invention shown in FIGS. 4-6, the receptacle 19 comprises a rectangular plate 20 having a pair of outlet aperture sets 22, 24 extending through the plate 20. A face plate 26 having a rectangular aperture 27 is adapted to be fastened to and over the receptacle. A rectangular outlet cup 28, with aperture sets 30, 32 aligned with aperture sets 22, 24, extends over the rectangular plate 20 and is held between face plate 26 and rectangular plate 20 (FIG. 5). Outlet cup 28 includes an outwardly extending flange 34 formed around the outside rim 35 of the cup 28 to cover any gap between the receptacle and the face plate 26 when the cup 28 is installed. Rim 35 also has an inner surface that provides a gripping surface to engage the outer perimeter of rectangular plate 20, and removably and snugly attach the cup 28 to the rectangular plate 20. The flange 34 also holds the outlet cup 28 in contact with and over rectangular plate 20 upon the attachment of face plate 26 to the receptacle, as seen in FIG. 5.

In another embodiment of the present invention as illustrated in FIG. 7, wall mounted light switches 40 having a finger operable portion 41 are also capable of color matching. Each light switch 40 receives a condom-like sleeve 42 having an inner chamber 44 in the shape of the finger operable switch portion 41, such that the sleeve 42 slides over the extant switch portion. In an embodiment, sleeve 42 comprises a hollow shell-like configuration with a small amount of tacky adhesive material on the inner surface of chamber 44 to hold sleeve 42 in place on switch portion 41. This tacky glue is compounded so that the sleeve 42 is permanently affixed to the wall switch portion 41, so as not to pose a choking hazard, and yet be removable in the future so that sleeve 42 can be updated should the room color change.

It is contemplated that sleeves 42 may be formed or molded into fanciful ornamental or decorative figures, such as animals, dolls, candy canes, or sports equipment such as baseballs, footballs, basketballs or the like. These ornamental sleeves 42 may be ideally suited for use in an infant's nursery or child's room, and could be replaced as the child grows older to match the child's interests as the child grows up.

The basic product line for both the outlet cups 10, 28 and switch sleeves 42 would include white/off-white/black/brown and black. They could also be manufactured to match popular colors of any paint company. This decorative detail would allow the homeowner to finish each room with the custom look they were looking for.

Additionally, the cover plates 12, 26, outlet cups 10 and switch sleeves 42 could be produced in a clear finish to allow the homeowner the ability to apply the exact paint used on the wall. The consumer could add a drop or two of the new wall color to the back of the clear outlet cups and/or switch sleeves prior to attaching the items into place—thereby insuring that the new cups and sleeves would perfectly match the new walls.

The foregoing description of a preferred embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specific, but be defined by the claims set forth below.

I claim:

1. A decorative electrical socket cover adapted to be placed over an electrical socket of an electrical outlet assembly, said outlet assembly located on a wall or other surface whereby the wall or other surface is finished in a predetermined color and a user desires that the color of the socket cover match the color of the wall or other surface, the decorative socket cover comprising:
a socket cup body having flat outwardly and inwardly facing surfaces and a rim portion extending around the perimeter of the socket cup body at substantially a right angle to the plane of the inwardly facing flat surface;
a plurality of apertures in the socket cup body adapted to correspond in size and location to a corresponding plurality of slots in the socket;
said rim portion including an inner surface providing a gripping surface;
said gripping surface of said rim portion adapted to engage an outer perimeter of said socket and removably attach said socket cup body to said socket.

2. The decorative electrical socket cover of claim 1, wherein said socket cup body includes a flange extending substantially perpendicular from and around the perimeter of the rim portion.

3. The decorative electrical socket cover of claim 2, wherein said flange is adapted to be engaged by a removable face plate when said socket cup body is placed over an electrical socket and the face plate is mounted on said outlet assembly.

4. A decorative electrical socket cover adapted to be placed over an electrical outlet assembly, said electrical outlet assembly including at least one electrical socket formed in a plate, the plate having a defined shape and edges extending around the plate, the edges defining the shape of the plate, the electrical socket cover comprising:
a socket cover body having flat outwardly and inwardly facing surfaces, and a rim portion extending around the perimeter of the socket cover body at substantially a right angle to the plane of the inwardly facing surface;
a plurality of slots in the socket cover body adapted to correspond in size and location to a corresponding plurality of slots in the at least one electrical socket;
said rim portion including an inner surface providing a gripping surface;
said gripping surface of said rim portion adapted to engage said edges of the plate and removably attach said socket cover body to said edges of said plate.

5. The decorative electrical socket cover of claim 4, wherein said socket cover includes a flange extending substantially perpendicular from and around the perimeter of the rim portion.

6. The decorative electrical socket cover of claim 5, wherein said flange is adapted to engage a removable face plate when said socket cover is placed over the electrical outlet assembly and the face plate is mounted on said electrical outlet assembly.

7. A decorative cover for the finger manipulable portion of an electrical wall switch, comprising:
a sleeve having an open end and a closed end;
a hollow chamber formed inside said sleeve, said open end of said sleeve communicating with said chamber;
said chamber having at least one wall;
a tacky adhesive material disposed on a portion of said wall, said adhesive material adapted to engage said finger manipulable portion of said wall switch when said finger manipulable portion is inserted into said chamber.
